(19) United States
(12) Patent Application Publication
(10) Pub. No.: US 2026/0003154 A1
(43) Pub. Date: Jan. 1, 2026

(54) LENS DEVICE AND IMAGING APPARATUS

(71) Applicant: FUJIFILM Corporation, Tokyo (JP)

(72) Inventors: Makoto KOBORI, Saitama (JP); Masami OKAMOTO, Saitama (JP)

(73) Assignee: FUJIFILM Corporation, Tokyo (JP)

(21) Appl. No.: 19/241,386

(22) Filed: Jun. 18, 2025

(30) Foreign Application Priority Data
Jun. 27, 2024 (JP) 2024-104034

(51) Int. Cl. G02B 7/02

(52) U.S. Cl. CPC G02B 7/021; G02B 7/022

(57) ABSTRACT

The lens device includes a rotating barrel that includes a spiral cam groove, a first lens frame that holds a first lens, a movable barrel that includes a first engaging member engaged with the cam groove and holds the first lens frame, and a stationary barrel that supports the movable barrel to be movable along a direction of an optical axis. The rotating barrel includes a first facing portion, and the movable barrel includes a second facing portion that faces the first facing portion with a first gap therebetween in the direction of the optical axis. The first engaging member includes a first elastic region, and the first gap is a gap corresponding to the first elastic region.

### CROSS-REFERENCE TO RELATED APPLICATIONS

This application claims priority under 35 USC 119 from Japanese Patent Application No. 2024-104034 filed on Jun. 27, 2024, the disclosure of which is incorporated by reference herein.

### BACKGROUND OF THE INVENTION

### 1. Field of the Invention

The technology of the present disclosure relates to a lens device and an imaging apparatus.

### 2. Description of the Related Art

JP2021-179474A discloses an optical device comprising an extending lens barrel that moves forward and backward in an optical axis direction, a cam follower provided in the extending lens barrel, a cam groove that is engaged with the cam follower, a cam barrel that has a protrusion portion provided to protrude toward an outer peripheral side and is rotatable about an optical axis, a frame member that covers a distal end part of the extending lens barrel and a part of an outer periphery of the cam barrel and moves forward and backward in the optical axis direction integrally with the extending lens barrel, an elastic member that biases the extending lens barrel and the frame member to be spaced from each other in the optical axis direction, and a regulating member that holds the extending lens barrel and the frame member in a state where a first gap is formed therebetween in the optical axis direction, in which a recess portion facing the protrusion portion in a radial direction is provided on an inner periphery of the frame member, and a second gap formed between the protrusion portion and the recess portion in the optical axis direction is smaller than the first gap.

JP2016-048283A discloses a lens barrel that is a zoom lens barrel in which a lens moves in an optical axis direction between a storage position and an imaging position to change an imaging magnification, the lens barrel comprising a stationary barrel that is provided with a plurality of first protrusions or follower portions on an outer peripheral portion and is provided with a flange portion on an outer peripheral portion of an end part on a subject side, a stopper member that is fixed and disposed substantially coaxially with the stationary barrel and is provided with a plurality of second protrusions or follower portions having a flank surface on the outer peripheral portion on both sides in the optical axis direction, and a cam barrel that is disposed on an outer peripheral side of the stationary barrel and the stopper member, is formed with a plurality of first cam grooves on an inner peripheral portion, each of which is cam-engaged with the plurality of first protrusions or follower portions, is formed with a plurality of second cam grooves having the same locus as the first cam grooves at a position separated from the first cam grooves on an image plane side in the optical axis direction, each of which is engaged with the plurality of second protrusions or follower portions, and in which the cam barrel moves in the optical axis direction while rotating with respect to the stationary barrel and the stopper member by engagement between the first protrusions or follower portions and the first cam grooves and engagement between the second protrusions or follower portions and the second cam grooves, in which in a region where the cam barrel is extended to the subject side and approaches the flange portion of the stationary barrel, side walls of the plurality of second cam grooves on the image plane side, each of which is engaged with the plurality of second protrusions or follower portions, are open.

JP2016-128852A discloses a lens barrel including a barrel-shaped movable unit that holds at least one or more lenses, is positioned closest to a subject side, and is movable forward and backward in an optical axis direction and that has a flange-shaped portion on the subject side, a cam ring that drives the movable unit to be movable forward and backward in the optical axis direction and is disposed on a radially inner side of the movable unit, a fixed sensor holding member that is disposed on an imaging surface side of the movable unit and on a radially outer side of the cam ring, and is provided with a sensor for detecting rotation of the cam ring, a reflective member holding frame that is disposed on a radially outer side of the sensor holding member, is provided with a reflective member for detecting a position by the sensor, and rotates integrally with the cam ring, a fixed first exterior member that is disposed on an outer side the reflective member, and a second exterior member that is provided on a subject side of the first exterior member and is connected and fixed to the first exterior member, in which, in a case where an impact is applied to an end surface of the barrel-shaped movable unit on the subject side, a surface of the flange-shaped portion on the imaging surface side abuts against the second exterior member, and a force of the impact is transmitted to the first exterior member via the second exterior member.

JP2019-113677A discloses a lens barrel comprising a first barrel-shaped member that has a cam groove and is rotatably disposed with an axis passing through a radial center as a central axis of rotation, and a second barrel-shaped member that has a cam follower engaged with the cam groove and holds an optical member and is movable forward and backward in an optical axis direction of the optical member according to rotation of the first barrel-shaped member, in which the first barrel-shaped member has a hole portion, the second barrel-shaped member has a stopper member that moves forward and backward with respect to the hole portion according to forward and backward movement of the second barrel-shaped member in the optical axis direction, and the hole portion has an abutting wall that is capable of abutting against the stopper member in the optical axis direction.

### SUMMARY OF THE INVENTION

One embodiment according to the technology of the present disclosure provides a lens device capable of suppressing a decrease in the optical performance as compared with the related art.

A first aspect according to the technology of the present disclosure is a lens device including a rotating barrel that includes a spiral cam groove, a first lens frame that holds a first lens, a movable barrel that includes a first engaging member engaged with the cam groove and holds the first lens frame, and a stationary barrel that supports the movable barrel to be movable along a direction of an optical axis, in which the rotating barrel includes a first facing portion, the movable barrel includes a second facing portion that faces the first facing portion with a first gap therebetween in the direction of the optical axis, the first engaging member includes a first clastic region, and the first gap is a gap corresponding to the first elastic region.

A second aspect according to the technology of the present disclosure is the lens device according to the first aspect, in which in a case where a deformation amount of the first engaging member in the direction of the optical axis, which corresponds to a yield point of the first engaging member, is denoted by A [mm] and a dimension of the first gap in the direction of the optical axis is denoted by B [mm], Expression (1) is satisfied, B<A . . . (1).

A third aspect according to the technology of the present disclosure is the lens device according to the second aspect, in which Expression (2) is satisfied, A×0.7≤B<A . . . (2).

A fourth aspect according to the technology of the present disclosure is the lens device according to the third aspect, in which B=0.050 mm is satisfied.

A fifth aspect according to the technology of the present disclosure is the lens device according to any one of the first to fourth aspects, in which the first gap is a gap in which the second facing portion abuts against the first facing portion before the first engaging member is plastically deformed beyond the first elastic region.

A sixth aspect according to the technology of the present disclosure is the lens device according to any one of the first to fifth aspects, in which the first engaging member is a roller of a cam follower.

A seventh aspect according to the technology of the present disclosure is the lens device according to any one of the first to sixth aspects, in which a material of the first engaging member is a material including resin, rubber, or an elastomer.

An eighth aspect according to the technology of the present disclosure is the lens device according to any one of the first to seventh aspects, in which the first engaging member is a roller of a cam follower selected according to a dimension of a width of the cam groove.

A ninth aspect according to the technology of the present disclosure is the lens device according to any one of the first to eighth aspects, in which the first facing portion is formed on a side wall portion of the cam groove.

A tenth aspect according to the technology of the present disclosure is the lens device according to the ninth aspect, in which the second facing portion is positioned on a subject side with respect to the side wall portion in the direction of the optical axis.

An eleventh aspect according to the technology of the present disclosure is the lens device according to any one of the first to tenth aspects, in which at least a part of the second facing portion overlaps with at least a part of the first engaging member when viewed from the direction of the optical axis.

A twelfth aspect according to the technology of the present disclosure is the lens device according to any one of the first to eleventh aspects, in which the movable barrel includes a plurality of the first engaging members, and a plurality of the second facing portions, and each of the second facing portions is provided at a position corresponding to each of the first engaging members.

A thirteenth aspect according to the technology of the present disclosure is the lens device according to the twelfth aspect, in which the number of the plurality of second facing portions is the same as the number of the plurality of first engaging members.

A fourteenth aspect according to the technology of the present disclosure is the lens device according to any one of the first to thirteenth aspects, in which the rotating barrel includes a cam barrel including the cam groove, and a connecting barrel disposed on an image formation side with respect to the cam barrel, an end part of the movable barrel on the image formation side is positioned on a radially outer side of the cam barrel, and the second facing portion is provided in a protruding shape on an inner peripheral surface of the end part.

A fifteenth aspect according to the technology of the present disclosure is the lens device according to any one of the first to fourteenth aspects, in which the stationary barrel includes a straight groove along the direction of the optical axis, the movable barrel includes a second engaging member engaged with the straight groove, and the second engaging member is disposed between a center of gravity position of the first lens and the first engaging member in the direction of the optical axis.

A sixteenth aspect according to the technology of the present disclosure is the lens device according to any one of the first to fifteenth aspects, in which the rotating barrel includes a cam barrel including the cam groove, and a connecting barrel disposed on an image formation side with respect to the cam barrel, and the connecting barrel is configured separately from the cam barrel and is connected to the cam barrel.

A seventeenth aspect according to the technology of the present disclosure is the lens device according to the sixteenth aspect, in which the connecting barrel includes a gear portion engaged with a drive unit.

An eighteenth aspect according to the technology of the present disclosure is the lens device according to the seventeenth aspect, in which the gear portion is formed at an end part of the connecting barrel on the image formation side.

A nineteenth aspect according to the technology of the present disclosure is the lens device according to any one of the sixteenth to eighteenth aspects, in which the connecting barrel has a shape that increases in diameter toward the image formation side.

A twentieth aspect according to the technology of the present disclosure is the lens device according to any one of the sixteenth to nineteenth aspects, in which an outer diameter of an end part of the connecting barrel on the image formation side is larger than an outer diameter of the cam barrel.

A twenty-first aspect according to the technology of the present disclosure is the lens device according to any one of the sixteenth to twentieth aspects, further including a second lens frame that holds a second lens, in which the second lens includes a third lens positioned on a radially inner side of the cam barrel, and a fourth lens positioned on a radially inner side of the connecting barrel, and an outer diameter of the fourth lens is larger than an outer diameter of the third lens.

A twenty-second aspect according to the technology of the present disclosure is the lens device according to any one of the sixteenth to twenty-first aspects, in which a material of the cam barrel is a material including a metal.

A twenty-third aspect according to the technology of the present disclosure is the lens device according to any one of the first to twenty-second aspects, further including a second lens frame that holds a second lens, in which the rotating barrel includes a support groove along a direction around the optical axis, the stationary barrel includes a third engaging member engaged with the support groove, the rotating barrel includes a third facing portion, the second lens frame includes a fourth facing portion that faces the third facing portion with a second gap therebetween in the direction of the optical axis, the third engaging member includes a second elastic region, and the second gap is a gap corresponding to the second elastic region.

A twenty-fourth aspect according to the technology of the present disclosure is the lens device according to the twenty-third aspect, in which the second gap is a gap corresponding to the first gap.

A twenty-fifth aspect according to the technology of the present disclosure is the lens device according to the twenty-third or twenty-fourth aspect, in which the second lens frame includes a fixing portion that is fixed to an imaging apparatus body, and at least a part of the fourth facing portion overlaps with at least a part of the fixing portion in the direction around the optical axis.

A twenty-sixth aspect according to the technology of the present disclosure is the lens device according to any one of the twenty-third to twenty-fifth aspects, in which the stationary barrel includes a plurality of the third engaging members, the second lens frame includes a plurality of the fourth facing portions, and at least one of the plurality of fourth facing portions is provided at a position corresponding to at least one of the plurality of third engaging members.

A twenty-seventh aspect according to the technology of the present disclosure is the lens device according to any one of the twenty-third to twenty-sixth aspects, in which the movable barrel includes a plurality of the second facing portions, the second lens frame includes a plurality of the fourth facing portions, and at least one of the plurality of fourth facing portions is provided at a position corresponding to at least one of the plurality of second facing portions.

A twenty-eighth aspect according to the technology of the present disclosure is an imaging apparatus including the lens device according to any one of the first to twenty-seventh aspects.

### BRIEF DESCRIPTION OF THE DRAWINGS

FIG. 1 is a perspective view of an imaging apparatus according to one embodiment of the technology of the present disclosure.

FIG. 2 is a longitudinal sectional view of a lens device.

FIG. 3 is a longitudinal sectional view of a peripheral portion of a straight roller member and a cam roller member.

FIG. 4 is a longitudinal sectional view of a peripheral portion of a support roller member.

FIG. 5 is a longitudinal sectional view showing a positional relationship between a center of gravity position of a first lens and the straight roller member.

FIG. 6 is a front view schematically showing the imaging apparatus.

FIG. 7 is a side view of a rotating barrel.

FIG. 8 is a perspective view of a cam barrel.

FIG. 9 is a longitudinal sectional view of the rotating barrel.

FIG. 10 is a perspective view of a movable barrel.

FIG. 11 is a longitudinal sectional view showing a positional relationship between a first impact receiving portion and the cam roller member.

FIG. 12 is a diagram schematically showing the positional relationship between the first impact receiving portion and the cam roller member.

FIG. 13 is a longitudinal sectional view of a peripheral portion of the first impact receiving portion.

FIG. 14 is a graph showing an example of a relationship between a stress σ and a strain ε for a material of a cam roller.

FIG. 15 is a plan view showing a positional relationship between the first impact receiving portion and a side wall portion of a cam groove.

FIG. 16 is a longitudinal sectional view of a peripheral portion of a second impact receiving portion.

FIG. 17 is a perspective view of a rotating barrel.

FIG. 18 is a diagram schematically showing a positional relationship between the second impact receiving portion and the support roller member.

FIG. 19 is a perspective view of a second lens frame.

FIG. 20 is a diagram schematically showing a positional relationship between the first impact receiving portion and the second impact receiving portion.

FIG. 21 is a diagram schematically showing a modification example of the positional relationship between the first impact receiving portion and the second impact receiving portion.

### DESCRIPTION OF THE PREFERRED EMBODIMENTS

Hereinafter, one embodiment of a lens device 14 according to the technology of the present disclosure will be described.

### (Configuration of Imaging Apparatus 10)

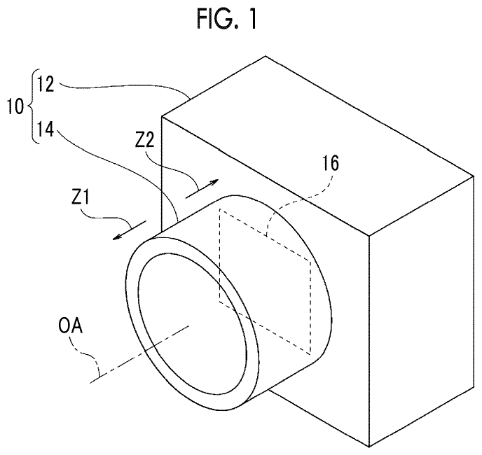

As shown in FIG. 1, an imaging apparatus 10 according to the present embodiment comprises an imaging apparatus body 12 and the lens device 14. An image sensor 16 is provided inside the imaging apparatus body 12. The lens device 14 is a device for forming an image of light on a light-receiving surface of the image sensor 16 and is attached to a front surface of the imaging apparatus body 12. The lens device 14 may be an integral type that is integrally provided in the imaging apparatus body 12 or may be a replaceable type that is replaceably provided in the imaging apparatus body 12.

The lens device 14 has an optical axis OA. Hereinafter, a direction of the optical axis OA (that is, a direction along the optical axis OA) will be referred to as an “optical axis direction”, and a direction around the optical axis OA with the optical axis OA as a center will be referred to as a “direction around the optical axis”. An arrow Z1 side indicates a subject side of the lens device 14, and an arrow Z2 side indicates an image formation side of the lens device 14.

### (Configuration of Lens Device 14)

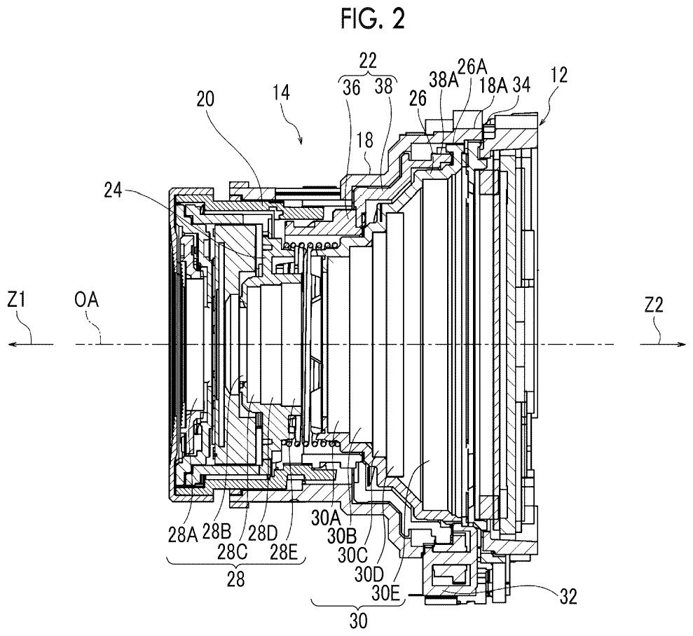

As shown in FIG. 2, the lens device 14 comprises a stationary barrel 18, a movable barrel 20, a rotating barrel 22, a first lens frame 24, a second lens frame 26, a first lens 28, a second lens 30, and a drive device 32. The stationary barrel 18, the movable barrel 20, the rotating barrel 22, the first lens frame 24, and the second lens frame 26 are all formed in a barrel shape (in other words, an annular shape) along the direction around the optical axis.

The stationary barrel 18 is disposed on a radially outer side of the movable barrel 20 and the rotating barrel 22. An end part 18A of the stationary barrel 18 on the image formation side is fixed to a fixing portion 34 provided on the front surface of the imaging apparatus body 12. As will be described in detail later, the rotating barrel 22 has a cam barrel 36 and a connecting barrel 38. The cam barrel 36 is disposed on the subject side with respect to the connecting barrel 38. The movable barrel 20 is disposed on a radially outer side of the cam barrel 36. The movable barrel 20 is disposed on the subject side with respect to the connecting barrel 38.

The first lens frame 24 is disposed on a radially inner side of the movable barrel 20. The second lens frame 26 is disposed on the image formation side with respect to the first lens frame 24. An end part 26A of the second lens frame 26 on the image formation side is formed in a flange shape. A portion of the second lens frame 26 excluding the end part 26A on the image formation side (that is, a portion of the second lens frame 26 on the subject side with respect to the end part 26A on the image formation side) is disposed on a radially inner side of the rotating barrel 22.

The first lens 28 is disposed on a radially inner side of the first lens frame 24. The first lens 28 is held by the first lens frame 24. The first lens 28 has a lens 28A, a lens 28B, a lens 28C, a lens 28D, and a lens 28E. The lenses 28A to 28E are disposed in order of the lens 28A, the lens 28B, the lens 28C, the lens 28D, and the lens 28E from the subject side to the image formation side.

The second lens 30 is disposed on a radially inner side of the second lens frame 26. The second lens 30 is held by the second lens frame 26. The second lens 30 is disposed on the subject side of the image sensor 16 and faces the image sensor 16 in the optical axis direction. The second lens 30 has a lens 30A, a lens 30B, a lens 30C, a lens 30D, and a lens 30E. The lenses 30A to 30E are disposed in order of the lens 30A, the lens 30B, the lens 30C, the lens 30D, and the lens 30E from the subject side to the image formation side. Outer diameters of the lenses 30A to 30D are large in the order of the lens 30A, the lens 30B, the lens 30C, the lens 30D, and the lens 30E.

The connecting barrel 38 has a shape that increases in diameter toward the image formation side. An outer diameter of an end part 38A of the connecting barrel 38 on the image formation side is larger than an outer diameter of the cam barrel 36. The lens 30A and the lens 30B are positioned on a radially inner side of the cam barrel 36. The lens 30C, the lens 30D, and the lens 30E are positioned on a radially inner side of the connecting barrel 38. The lens 30A and the lens 30B are examples of a “third lens” according to the technology of the present disclosure, and the lens 30C, the lens 30D, and the lens 30E are examples of a “fourth lens” according to the technology of the present disclosure. Each outer diameter of the lens 30C, the lens 30D, and the lens 30E is larger than each outer diameter of the lens 30A and the lens 30B.

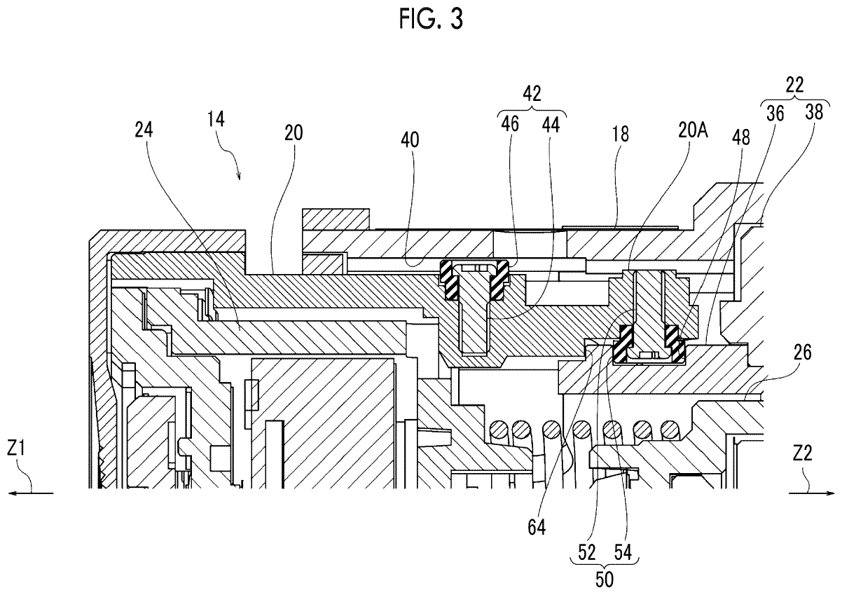

As shown in FIG. 3, the stationary barrel 18 has a straight groove 40. The straight groove 40 is formed on an inner peripheral surface of the stationary barrel 18. The straight groove 40 extends linearly along the optical axis direction. In FIG. 3, one straight groove 40 is shown, but the stationary barrel 18 has a plurality of the straight grooves 40. The number of the plurality of straight grooves 40 is, for example, three. The plurality of straight grooves 40 are formed at equal intervals in a circumferential direction of the stationary barrel 18.

The movable barrel 20 has a straight roller member 42. The straight roller member 42 is provided on the subject side with respect to an end part 20A of the movable barrel 20 on the image formation side. The straight roller member 42 has a shaft member 44 and a straight roller 46. The straight roller 46 is an example of a “second engaging member” according to the technology of the present disclosure. The shaft member 44 is provided along a radial direction of the movable barrel 20. A distal end part of the shaft member 44 protrudes from an outer peripheral surface of the movable barrel 20. A cam follower is provided at the distal end part of the shaft member 44, and the straight roller 46 is a roller of the cam follower. The straight roller 46 is rotatably supported at the distal end part of the shaft member 44.

The straight roller 46 is engaged with the straight groove 40. In FIG. 3, one straight roller member 42 is shown, but the movable barrel 20 has a plurality of the straight roller members 42. The number of the plurality of straight roller members 42 is, for example, three. The plurality of straight roller members 42 are provided at equal intervals in a circumferential direction of the movable barrel 20. Each straight roller 46 is engaged with the straight groove 40 to be movable relative to each other. The movable barrel 20 is supported by the stationary barrel 18 to be movable along the optical axis direction by the straight roller 46 being engaged with the straight groove 40.

The straight roller 46 is formed of an elastic material. The material of the straight roller 46 is, for example, a material including resin, rubber, or an elastomer. During assembly of the lens device 14, a plurality of cam followers having different outer diameters are prepared, and a cam follower having the straight roller 46 that matches the dimension of the width of the straight groove 40 is selected from among the plurality of cam followers according to the dimension of the width of the straight groove 40 (in other words, the dimensional error).

The cam barrel 36 has a cam groove 48. The cam groove 48 is formed on an outer peripheral surface of the cam barrel 36. The cam barrel 36 is formed in a spiral shape that spirals in the direction around the optical axis. The movable barrel 20 has a cam roller member 50. The cam roller member 50 is provided at the end part 20A of the movable barrel 20 on the image formation side. The end part 20A of the movable barrel 20 on the image formation side is positioned on the radially outer side of the cam barrel 36. The cam roller member 50 has a shaft member 52 and a cam roller 54. The cam roller 54 is an example of a “first engaging member” according to the technology of the present disclosure. The shaft member 52 is provided along the radial direction of the movable barrel 20. A distal end part of the shaft member 52 protrudes from an inner peripheral surface of the movable barrel 20. A cam follower is provided at the distal end part of the shaft member 52, and the cam roller 54 is a roller of the cam follower. The cam roller 54 is rotatably supported at the distal end part of the shaft member 52.

The cam roller 54 is engaged with the cam groove 48. In FIG. 3, one cam roller member 50 is shown, but the movable barrel 20 has a plurality of the cam roller members 50. The number of the plurality of cam roller members 50 is, for example, three. The plurality of cam roller members 50 are provided at equal intervals in the circumferential direction of the movable barrel 20. Each cam roller 54 is engaged with the cam groove 48 to be movable relative to each other. The rotating barrel 22 including the cam barrel 36 is supported by the movable barrel 20 to be rotatable in the direction around the optical axis by the cam roller 54 being engaged with the cam groove 48.

The cam roller 54 is formed of an elastic material. The material of the cam roller 54 is, for example, a material including resin, rubber, or an elastomer. During assembly of the lens device 14, a plurality of cam followers having different outer diameters are prepared, and a cam follower having the cam roller 54 that matches the dimension of the width of the cam groove 48 is selected from among the plurality of cam followers according to the dimension of the width of the cam groove 48 (in other words, the dimensional error).

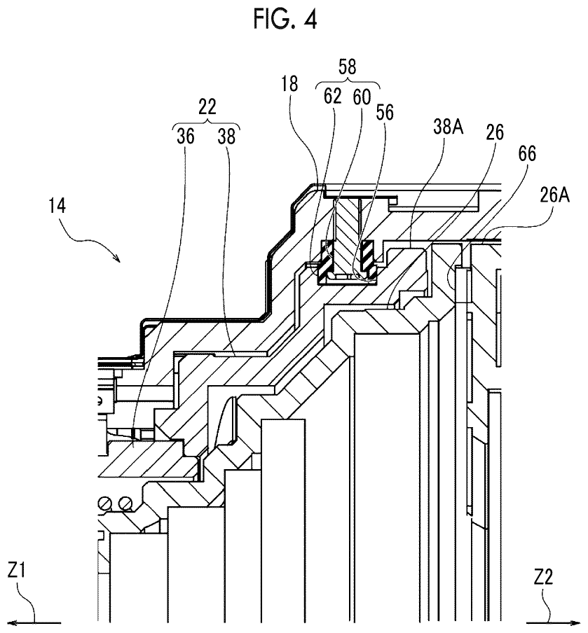

As shown in FIG. 4, the connecting barrel 38 has a support groove 56. The support groove 56 is formed on an outer peripheral surface of the end part 38A of the connecting barrel 38 on the image formation side. The support groove 56 is formed in an arc shape or an annular shape along the direction around the optical axis. The stationary barrel 18 has a support roller member 58. The support roller member 58 has a shaft member 60 and a support roller 62. The support roller 62 is an example of a “third engaging member” according to the technology of the present disclosure. The shaft member 60 is provided along a radial direction of the stationary barrel 18. A distal end part of the shaft member 60 protrudes from the inner peripheral surface of the stationary barrel 18. A cam follower is provided at the distal end part of the shaft member 60, and the support roller 62 is a roller of the cam follower. The support roller 62 is rotatably supported at the distal end part of the shaft member 60.

The support roller 62 is engaged with the support groove 56. In FIG. 4, one support roller member 58 is shown, but the stationary barrel 18 has a plurality of the support roller members 58. The number of the plurality of support roller members 58 is, for example, three. The plurality of support roller members 58 are provided at equal intervals in the circumferential direction of the stationary barrel 18. Each support roller 62 is engaged with the support groove 56 to be movable relative to each other. The rotating barrel 22 including the connecting barrel 38 is supported by the stationary barrel 18 to be rotatable in the direction around the optical axis by the support roller 62 being engaged with the support groove 56.

The support roller 62 is formed of an elastic material. The material of the support roller 62 is, for example, a material including resin, rubber, or an elastomer. During assembly of the lens device 14, a plurality of cam followers having different outer diameters are prepared, and a cam follower having the support roller 62 that matches the dimension of the width of the support groove 56 is selected from among the plurality of cam followers according to the dimension of the width of the support groove 56 (in other words, the dimensional error).

As shown in FIG. 3, the movable barrel 20 has a first impact receiving portion 64. The first impact receiving portion 64 is an example of a “second facing portion” according to the technology of the present disclosure. The first impact receiving portion 64 is formed at the end part 20A of the movable barrel 20 on the image formation side. As shown in FIG. 4, the second lens frame 26 has a second impact receiving portion 66. The second impact receiving portion 66 is an example of a “fourth facing portion” according to the technology of the present disclosure. The second impact receiving portion 66 is formed at the end part 26A of the second lens frame 26 on the image formation side. The first impact receiving portion 64 and the second impact receiving portion 66 are portions that receive an impact in a case where an impact is applied to the lens device 14 by dropping the imaging apparatus 10 (see FIG. 1) or the like. The first impact receiving portion 64 and the second impact receiving portion 66 will be described in detail later.

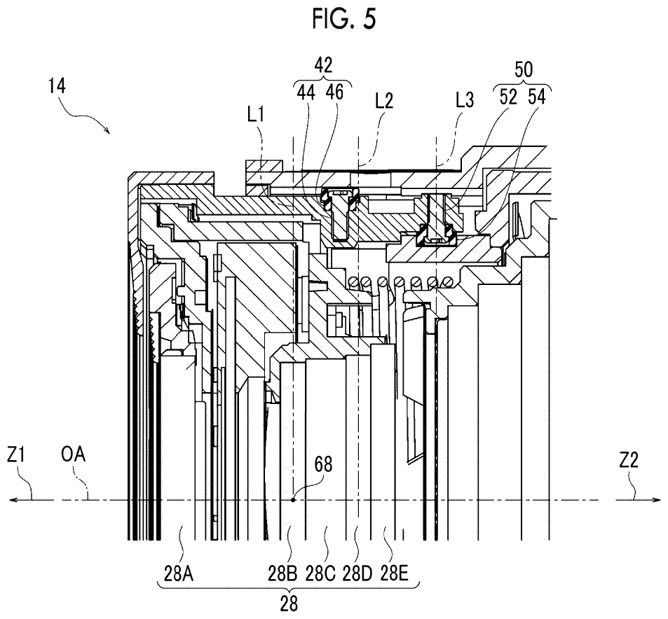

As shown in FIG. 5, the first lens 28 has a center of gravity 68. A virtual line L1 is a line passing through the center of gravity 68 of the first lens 28 in a side view of the lens device 14 and orthogonal to the optical axis direction. A virtual line L2 is a line passing through a rotation axis of the straight roller 46. A virtual line L3 is a line passing through a rotation axis of the cam roller 54. The straight roller 46 is disposed between a position of the center of gravity 68 of the first lens 28 and the cam roller 54 in the optical axis direction. More specifically, the straight roller 46 is disposed on the side of the center of gravity 68 of the first lens 28 with respect to the center portion between the position of the center of gravity 68 of the first lens 28 and the cam roller 54 in the optical axis direction.

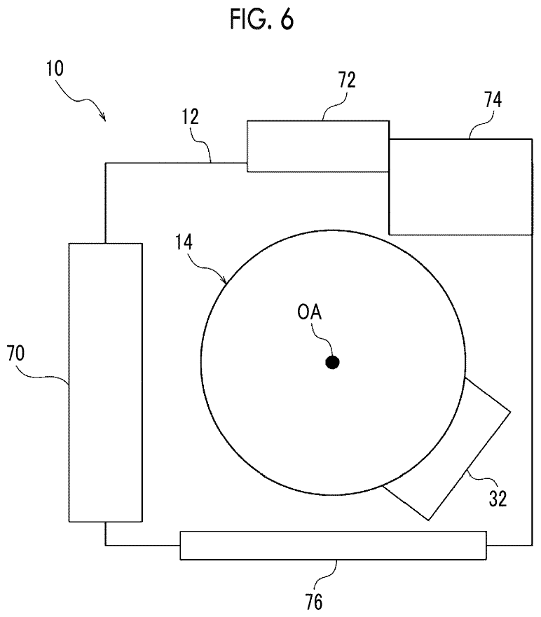

As shown in FIG. 6, the imaging apparatus body 12 comprises a battery 70, a hot shoe microphone 72, a finder 74, and a tripod mount 76. The battery 70 is provided on one side portion (for example, a right side portion) of the imaging apparatus body 12. The hot shoe microphone 72 is provided on an upper portion of the imaging apparatus body 12. The finder 74 is provided at an upper corner portion of the imaging apparatus body 12 on a side opposite to the battery 70. The drive device 32 is positioned at a lower corner portion of the imaging apparatus body 12 on a side opposite to the battery 70. The tripod mount 76 is provided on a lower portion of the imaging apparatus body 12.

The drive device 32 is a motor actuator having a motor, a reduction mechanism, and the like. The drive device 32 is an example of a “drive unit” according to the technology of the present disclosure. Examples of the motor used in the drive device 32 include a DC motor and a stepping motor.

The drive device 32 is a device for rotating the rotating barrel 22 (see FIGS. 2 to 4) in two directions. In a case where the rotating barrel 22 is rotated, the cam roller 54 moves relative to the cam groove 48, so that the rotational movement of the rotating barrel 22 is converted into the linear movement of the movable barrel 20, and the movable barrel 20 moves along the optical axis direction. The first lens frame 24 is fixed to the movable barrel 20 and moves integrally with the movable barrel 20. The second lens frame 26 is fixed to the stationary barrel 18.

Hereinafter, more detailed configurations of the above-described rotating barrel 22, the first impact receiving portion 64, and the second impact receiving portion 66 will be described in order.

### (Configuration of Rotating Barrel 22)

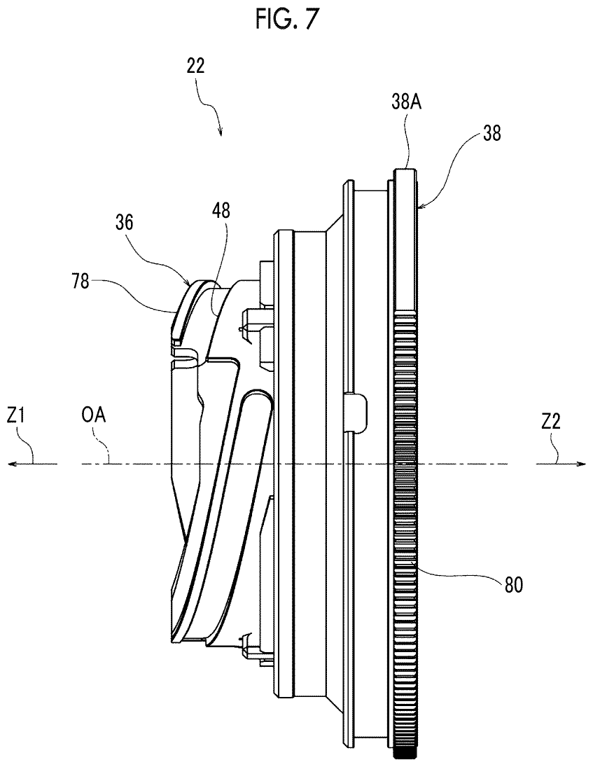

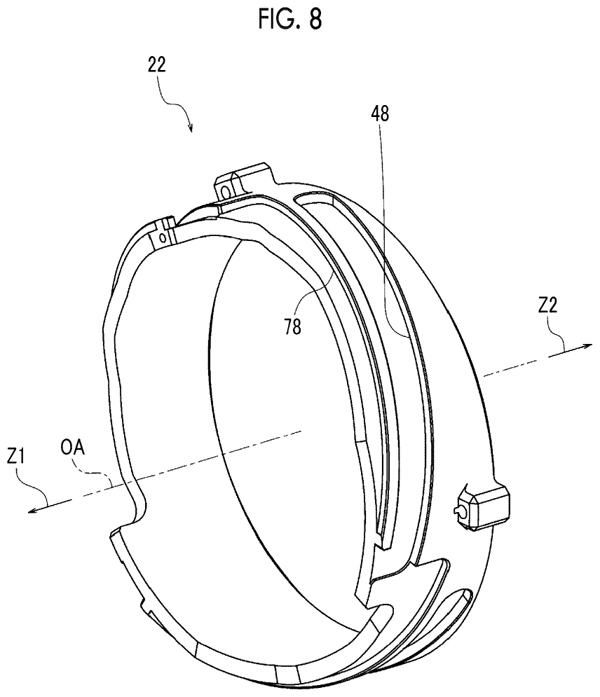

As shown in FIG. 7, as described above, the rotating barrel 22 has the cam barrel 36 having the cam groove 48 and the connecting barrel 38 disposed on the image formation side with respect to the cam barrel 36. The connecting barrel 38 is configured separately from the cam barrel 36. Materials of the cam barrel 36 and the connecting barrel 38 are materials including a metal. Examples of the metal of the cam barrel 36 and the connecting barrel 38 include aluminum. In FIG. 8, the cam barrel 36 is shown alone.

The cam barrel 36 has a side wall portion 78 of the cam groove 48. The side wall portion 78 is an example of a “first facing portion” according to the technology of the present disclosure. The side wall portion 78 is positioned on the subject side with respect to the cam groove 48. The side wall portion 78 is formed over one end part to the other end part of the cam groove 48 in a length direction (that is, a direction along a spiral). The cam groove 48 is, for example, formed by a bottomed groove.

The connecting barrel 38 has a gear portion 80. The gear portion 80 is formed at the end part 38A of the connecting barrel 38 on the image formation side. The gear portion 80 is formed in an arc shape along the direction around the optical axis. The gear portion 80 is engaged with a gear provided in the reduction mechanism of the drive device 32 (see FIG. 6). In a case where the motor of the drive device 32 rotates the gear, the rotating barrel 22 rotates integrally with the gear portion 80.

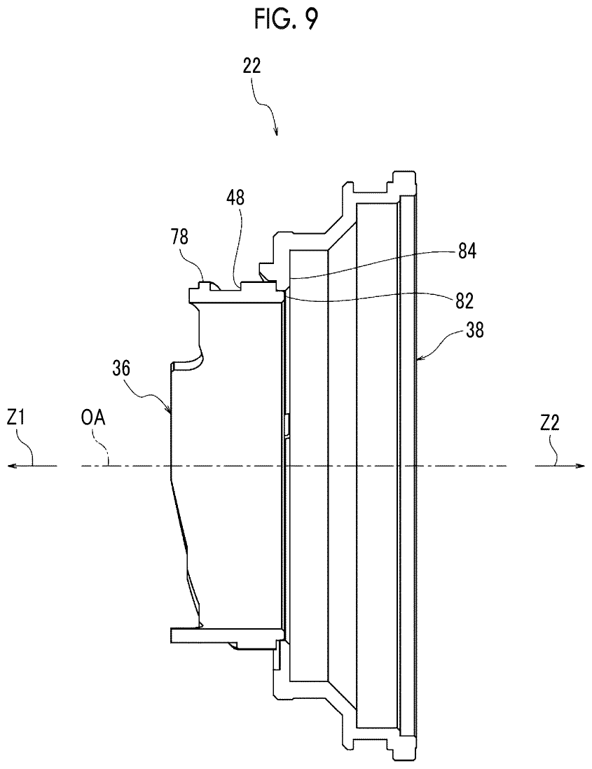

As shown in FIG. 9, a first fitting portion 82 is formed at an end part of the cam barrel 36 on the image formation side, and a second fitting portion 84 is formed at an end part of the connecting barrel 38 on the subject side. The second fitting portion 84 is fitted to the first fitting portion 82, so that the connecting barrel 38 is connected to the cam barrel 36.

### (Configuration of First Impact Receiving Portion 64)

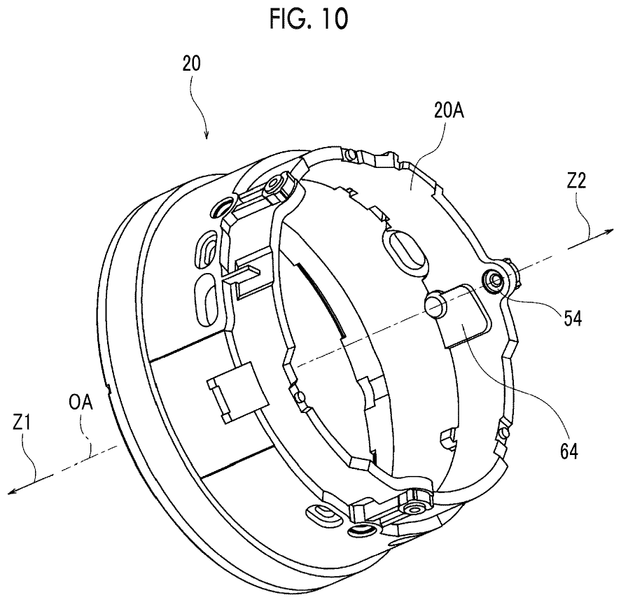

As shown in FIG. 10, the first impact receiving portion 64 is formed on an inner peripheral surface of the end part 20A of the movable barrel 20 on the image formation side. The first impact receiving portion 64 is provided in a protruding shape on the inner peripheral surface of the end part 20A. That is, the first impact receiving portion 64 is formed in a shape in which a part of the inner peripheral surface of the end part 20A is bulged toward the radially inner side of the movable barrel 20. The first impact receiving portion 64 is positioned on the subject side with respect to the cam roller 54.

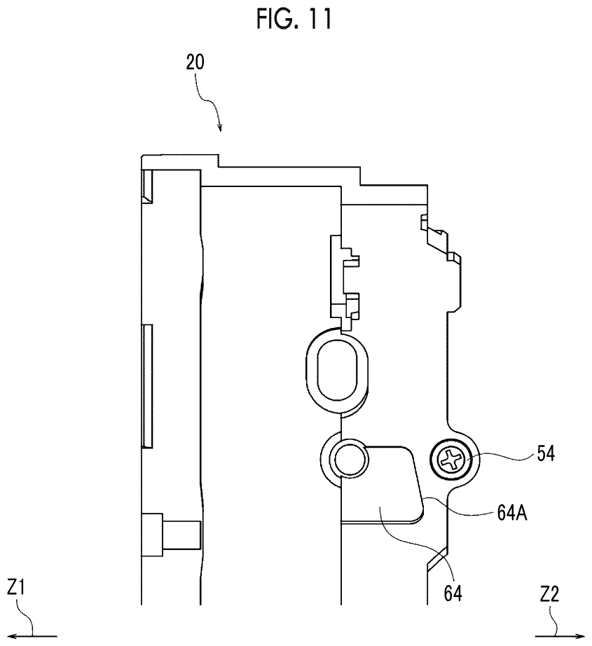

As shown in FIG. 11, the first impact receiving portion 64 has a side surface 64A. The side surface 64A is an example of a “second facing surface” according to the technology of the present disclosure. The side surface 64A is a surface of the first impact receiving portion 64 on the image formation side. The side surface 64A is inclined with respect to a direction orthogonal to the optical axis direction when viewed from the radial direction of the movable barrel 20.

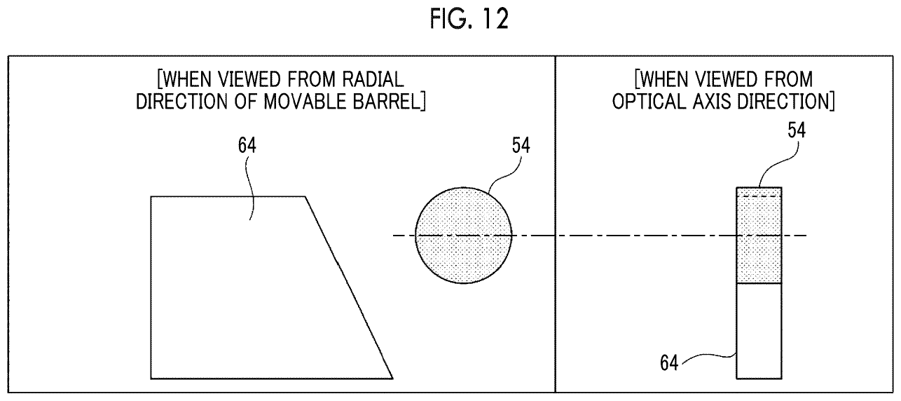

As shown in FIG. 12, in a case where a width direction of the first impact receiving portion 64 is a direction along the circumferential direction of the movable barrel 20, at least a part of the first impact receiving portion 64 in the width direction overlaps with at least a part of the cam roller 54 when viewed from the optical axis direction. In the present embodiment, for example, a part of the first impact receiving portion 64 in the width direction overlaps with a part of the cam roller 54 when viewed from the optical axis direction.

The entire first impact receiving portion 64 in the width direction may overlap with the entire cam roller 54 when viewed from the optical axis direction, and the entire first impact receiving portion 64 in the width direction may overlap with a part of the cam roller 54 when viewed from the optical axis direction. In addition, a part of the first impact receiving portion 64 in the width direction may overlap with the entire cam roller 54 when viewed from the optical axis direction.

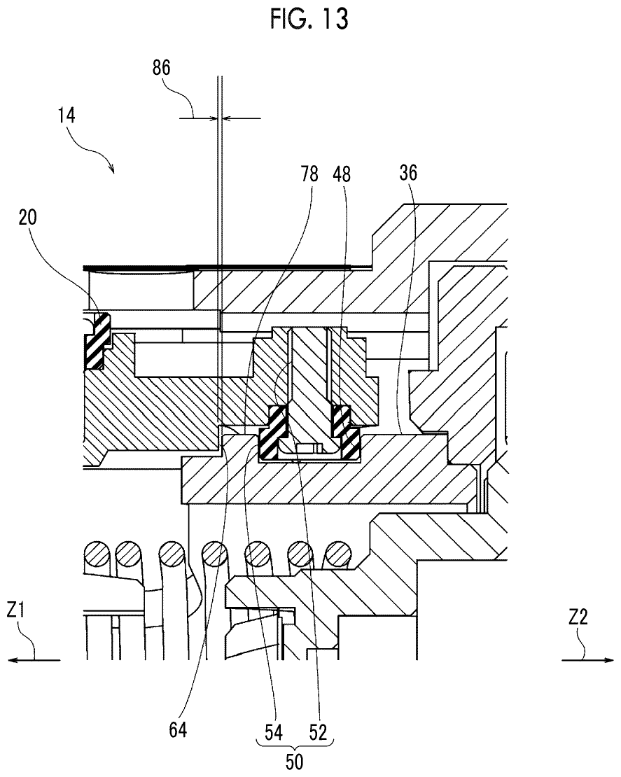

As shown in FIG. 13, the first impact receiving portion 64 faces the side wall portion 78 of the cam groove 48 with a first gap 86 therebetween in the optical axis direction. The cam barrel 36 rotates with respect to the movable barrel 20. Therefore, in order to ensure the rotation of the cam barrel 36, the first gap 86 is ensured between the movable barrel 20 and the cam barrel 36. However, in a case where the movable barrel 20 is moved to the image formation side due to an impact applied to the lens device 14 by dropping the imaging apparatus 10 or the like, the cam roller 54 may be plastically deformed beyond an elastic region by interfering with a side surface of the cam groove 48 on the image formation side. In a case where the cam roller 54 is plastically deformed, the rotational accuracy of the cam barrel 36 and the straight movement accuracy of the movable barrel 20 may be decreased, which may cause a decrease in the optical performance of the lens device 14.

Therefore, the first gap 86 is set to a dimension corresponding to the elastic region of the cam roller 54. In other words, the first gap 86 is set to a dimension at which the first impact receiving portion 64 abuts against the side wall portion 78 of the cam groove 48 before the cam roller 54 is plastically deformed beyond the elastic region.

Specifically, in a case where a deformation amount of the cam roller 54 in the optical axis direction (that is, a deformation amount of the cam roller 54 in the radial direction), which corresponds to a yield point of a material forming the cam roller 54, is denoted by A [mm] and a dimension of the first gap 86 in the optical axis direction is denoted by B [mm], the dimension B [mm] of the first gap 86 is set to a dimension satisfying Expression (1). In addition, more specifically, the dimension B [mm] of the first gap 86 is set to a dimension satisfying Expression (2).

$$B < A \qquad ( 1 )$$

$$A \times 0.7 \leq B < A \qquad ( 2 )$$

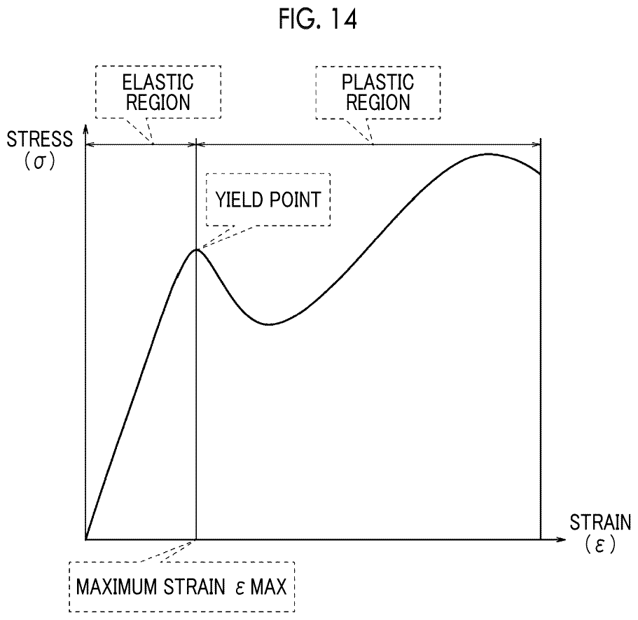

In FIG. 14, an example of a relationship between a stress σ and a strain ε for the material of the cam roller 54 is shown. The deformation amount A is obtained based on the maximum strain εmax corresponding to the yield point. The dimension B of the first gap 86 is, for example, 0.0050 mm. In a case where the dimension B is less than the dimension of the deformation amount A×0.7 (that is, 70% of the deformation amount A), the cam barrel 36 may interfere with the movable barrel 20 during rotation. On the other hand, in a case where the dimension B is equal to or greater than the dimension of the deformation amount A, in a case where an impact is applied to the lens device 14 by dropping the imaging apparatus 10 or the like, the cam roller 54 may be plastically deformed beyond the elastic region, so that the rotational accuracy of the cam barrel 36 and the straight movement accuracy of the movable barrel 20 may be decreased, and the optical performance of the lens device 14 may be decreased. The elastic region of the cam roller 54 is an example of a “first elastic region” according to the technology of the present disclosure.

As shown in FIG. 15, the side wall portion 78 of the cam groove 48 has a side surface 78A. The side surface 78A is an example of a “first facing surface” according to the technology of the present disclosure. The side surface 78A is a surface of the side wall portion 78 on the subject side. The side surface 78A is formed along the spiral cam groove 48, so that the side surface 78A is inclined with respect to the direction orthogonal to the optical axis direction when viewed from the radial direction of the cam barrel 36.

The first impact receiving portion 64 is positioned on a side opposite to the cam roller 54 with respect to the side wall portion 78 in the optical axis direction. That is, the first impact receiving portion 64 is positioned on the subject side with respect to the cam roller 54. As described above, the first impact receiving portion 64 has the side surface 64A (see also FIG. 11). The side surface 64A is a surface of the first impact receiving portion 64 on the image formation side. The side surface 64A is inclined with respect to the direction orthogonal to the optical axis direction when viewed from the radial direction of the movable barrel 20. An inclination angle of the side surface 64A corresponds to an inclination angle of the side surface 78A of the side wall portion 78. The side surface 64A of the first impact receiving portion 64 faces the side surface 78A of the side wall portion 78 in the optical axis direction.

In FIGS. 13 and 15, one first impact receiving portion 64 is shown, but the movable barrel 20 has a plurality of the first impact receiving portions 64. The number of the plurality of first impact receiving portions 64 is the same as the number of the plurality of cam roller members 50. The number of the plurality of first impact receiving portions 64 is, for example, three. The plurality of first impact receiving portions 64 are formed at equal intervals in the circumferential direction of the movable barrel 20. Each of the first impact receiving portions 64 is provided at a position corresponding to each of the cam rollers 54. That is, as described above, at least a part of each of the first impact receiving portions 64 in the width direction overlaps with at least a part of each of the cam rollers 54 when viewed from the optical axis direction (see FIGS. 11 and 12).

### (Configuration of Second Impact Receiving Portion 66)

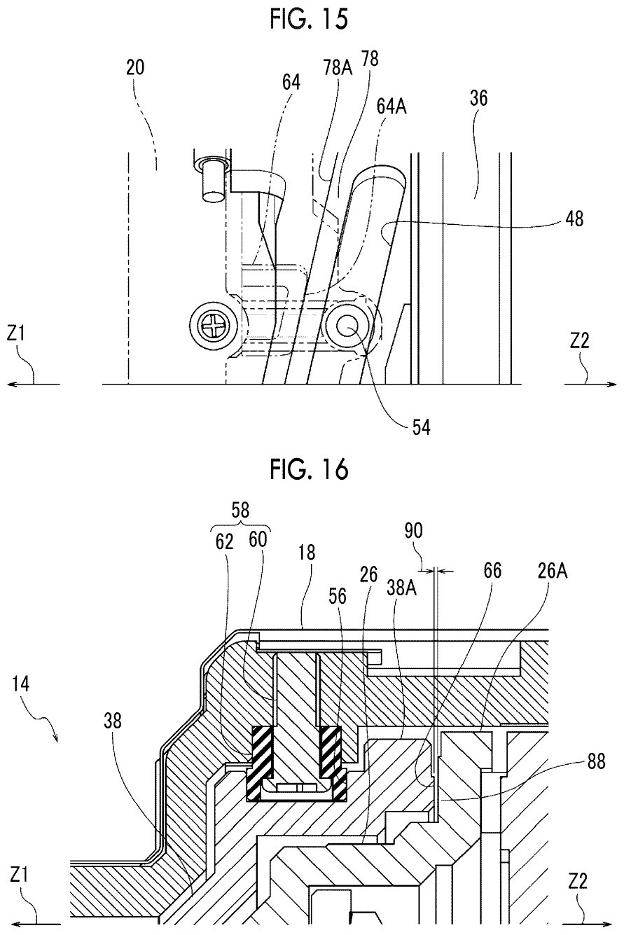

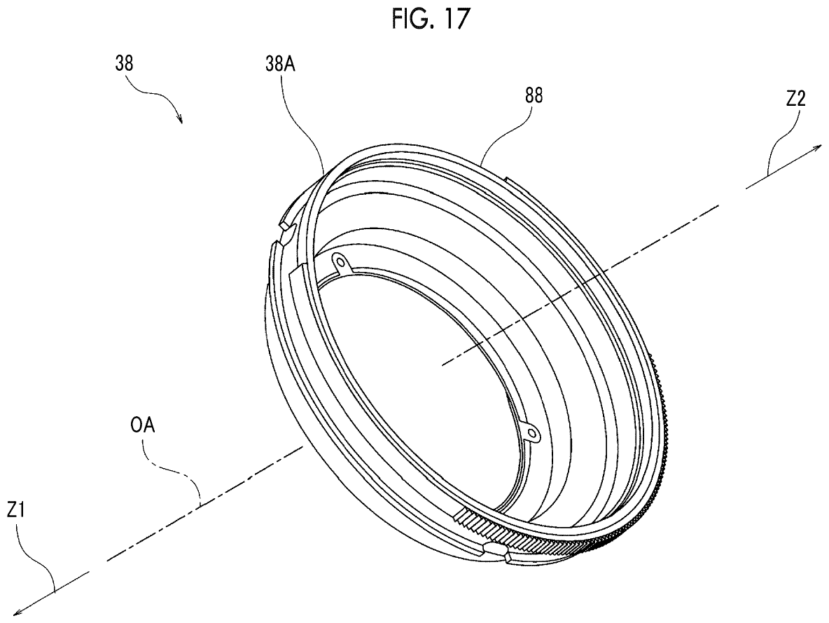

As shown in FIG. 16, the second impact receiving portion 66 is formed on a surface on the subject side at the end part 26A of the second lens frame 26 on the image formation side. The second impact receiving portion 66 is formed in a protruding shape protruding from the surface of the end part 26A on the subject side toward the subject side. The second impact receiving portion 66 is positioned on the image formation side with respect to the support roller 62. A convex portion 88 (see also FIG. 17) that protrudes toward the image formation side is formed on a surface on the image formation side at the end part 38A of the connecting barrel 38 on the image formation side. The convex portion 88 is an example of a “third facing portion” according to the technology of the present disclosure. The convex portion 88 is formed in an annular shape along a circumferential direction of the connecting barrel 38.

The second impact receiving portion 66 faces the convex portion 88 with a second gap 90 therebetween in the optical axis direction. The connecting barrel 38 rotates with respect to the second lens frame 26. Therefore, in order to ensure the rotation of the connecting barrel 38, the second gap 90 is ensured between the connecting barrel 38 and the second lens frame 26. However, in a case where the movable barrel 20 and the rotating barrel 22 are moved to the image formation side due to an impact applied to the lens device 14 by dropping the imaging apparatus 10 or the like, the support roller 62 may be plastically deformed beyond the elastic region by interfering with a side surface of the support groove 56 on the image formation side. In a case where the support roller 62 is plastically deformed, the rotational accuracy of the cam barrel 36 (see FIG. 2) connected to the connecting barrel 38 and the straight movement accuracy of the movable barrel 20 (see FIG. 2) may be decreased, which may cause a decrease in the optical performance of the lens device 14.

Therefore, the second gap 90 is set to a dimension corresponding to the elastic region of the support roller 62. In other words, the second gap 90 is set to a dimension at which the second impact receiving portion 66 abuts against the convex portion 88 before the support roller 62 is plastically deformed beyond the elastic region. For example, the same roller as the cam roller 54 (see FIG. 13) is used for the support roller 62, and the dimension of the second gap 90 corresponds to the dimension of the first gap 86. That is, the dimension of the second gap 90 is set to be the same as the dimension of the first gap 86. The elastic region of the support roller 62 is an example of a “second elastic region” according to the technology of the present disclosure.

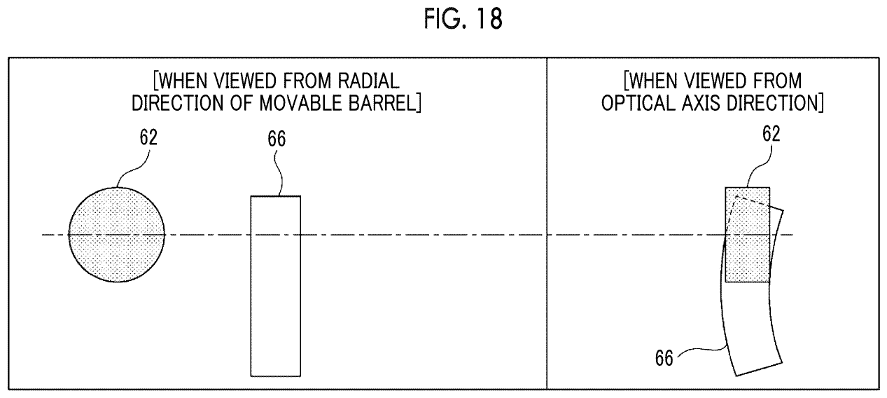

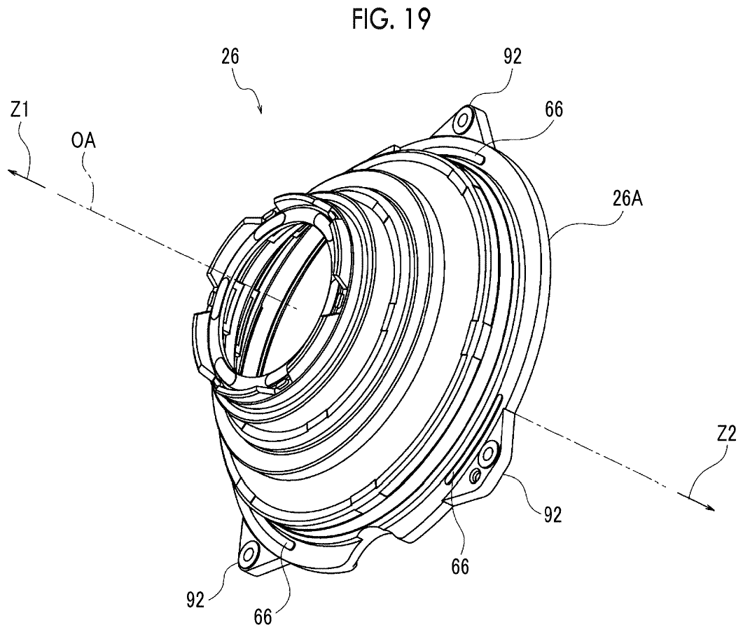

As shown in FIG. 18, in a case where a width direction of the second impact receiving portion 66 is a direction along a circumferential direction of the second lens frame 26, at least a part of the second impact receiving portion 66 in the width direction overlaps with at least a part of the support roller 62 when viewed from the optical axis direction. In the present embodiment, for example, a part of the second impact receiving portion 66 in the width direction overlaps with a part of the support roller 62 when viewed from the optical axis direction.

The entire second impact receiving portion 66 in the width direction may overlap with the entire support roller 62 when viewed from the optical axis direction, and the entire second impact receiving portion 66 in the width direction may overlap with a part of the support roller 62 when viewed from the optical axis direction. In addition, a part of the second impact receiving portion 66 in the width direction may overlap with the entire support roller 62 when viewed from the optical axis direction.

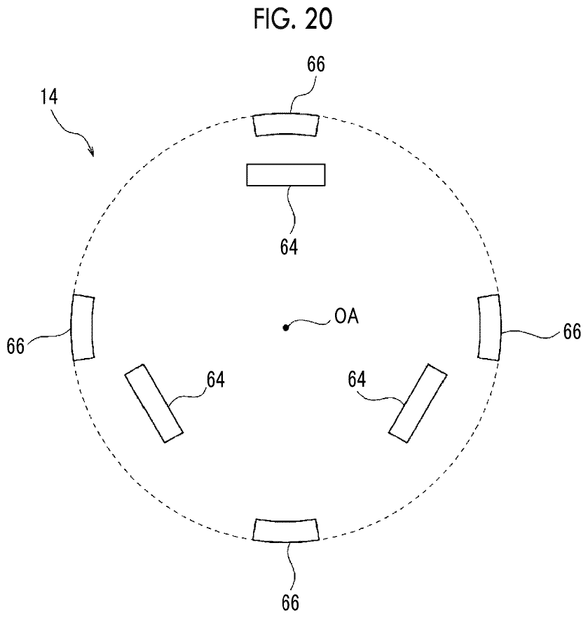

In FIG. 16, one second impact receiving portion 66 is shown, but as shown in FIG. 19, the second lens frame 26 has a plurality of the second impact receiving portions 66. A plurality of fixing portions 92 are formed at the end part 26A of the second lens frame 26 on the image formation side. The plurality of fixing portions 92 are fixed to the imaging apparatus body 12 (see FIG. 2). The number of the plurality of second impact receiving portions 66 is the same as the number of the plurality of fixing portions 92. The number of the plurality of second impact receiving portions 66 is, for example, four. The plurality of second impact receiving portions 66 are formed at equal intervals in a circumferential direction of the second lens frame 26.

Any one second impact receiving portion 66 of the plurality of second impact receiving portions 66 (for example, four impact receiving portions) is provided at a position corresponding to any one support roller 62 of the plurality of support rollers 62 (for example, three support rollers 62). That is, as described above, at least a part of any one of the second impact receiving portions 66 in the width direction overlaps with at least a part of the support roller 62 when viewed from the optical axis direction (see FIG. 18).

In addition, at least a part of the second impact receiving portion 66 in the width direction overlaps with at least a part of the fixing portion 92 in the direction around the optical axis. In the present embodiment, for example, a part of the second impact receiving portion 66 in the width direction overlaps with a part of the fixing portion 92 in the direction around the optical axis.

The entire second impact receiving portion 66 in the width direction may overlap with the entire fixing portion 92 in the direction around the optical axis, and the entire second impact receiving portion 66 in the width direction may overlap with a part of the fixing portion 92 in the direction around the optical axis. In addition, a part of the second impact receiving portion 66 in the width direction may overlap with the entire fixing portion 92 in the direction around the optical axis.

As shown in FIG. 20, any one second impact receiving portion 66 of the plurality of second impact receiving portions 66 (for example, four impact receiving portions) is provided at a position corresponding to any one first impact receiving portion 64 of the plurality of first impact receiving portions 64 (for example, three impact receiving portions) described above. That is, any one of the second impact receiving portions 66 is provided at the same position as any one of the first impact receiving portions 64 in the direction around the optical axis.

### Effects

As described above in detail, in the lens device 14 according to the present embodiment, the movable barrel 20 has the first impact receiving portion 64 that faces the side wall portion 78 of the cam groove 48 with the first gap 86 therebetween in the optical axis direction (see FIG. 13). The cam roller 54 is formed of an elastic material. The first gap 86 is a gap corresponding to the elastic region of the cam roller 54. Therefore, in a case where the movable barrel 20 is moved to the image formation side and the cam roller 54 is elastically deformed due to an impact applied to the lens device 14 by dropping the imaging apparatus 10 or the like, the first impact receiving portion 64 abuts against the side wall portion 78 of the cam groove 48. Accordingly, since the cam roller 54 can be suppressed from being plastically deformed beyond the clastic region, it is possible to suppress the rotational accuracy of the cam barrel 36 and the straight movement accuracy of the movable barrel 20 from being decreased. As a result, it is possible to suppress a decrease in the optical performance of the lens device 14.

In addition, the facing portion that faces the first impact receiving portion 64 with the first gap 86 therebetween in the optical axis direction is the side wall portion 78 of the cam groove 48 (see FIG. 13). Therefore, for example, the structure of the lens device 14 can be simplified as compared with a case where the facing portion is provided other than the side wall portion 78 of the cam groove 48.

In addition, at least a part of the first impact receiving portion 64 in the width direction overlaps with at least a part of the cam roller 54 when viewed from the optical axis direction (see FIG. 12). Therefore, for example, the first impact receiving portion 64 can receive the impact at a position close to the cam roller 54 as compared with a case where the first impact receiving portion 64 is shifted without overlapping with the cam roller 54 when viewed from the optical axis direction. Accordingly, it is possible to enhance the effect of suppressing the cam roller 54 from being plastically deformed beyond the clastic region.

In addition, the movable barrel 20 has the plurality of cam roller members 50 and the plurality of first impact receiving portions 64, and each of the first impact receiving portions 64 is provided at a position corresponding to each of the cam rollers 54 (see FIG. 11). Therefore, each of the first impact receiving portions 64 corresponding to each of the cam rollers 54 can receive the impact. As a result, it is possible to enhance the effect of suppressing each of the cam rollers 54 from being plastically deformed beyond the clastic region as compared with a case where each of the first impact receiving portions 64 is provided without corresponding to any of the cam rollers 54.

In addition, the straight roller 46 is disposed between the position of the center of gravity 68 of the first lens 28 and the cam roller 54 in the optical axis direction (see FIG. 5). Therefore, for example, it is possible to reduce a moment acting on the straight roller 46, which is a moment acting in the direction orthogonal to the optical axis direction with the center of gravity 68 of the first lens 28 as a center, as compared with a case where the straight roller 46 is disposed at a position separated from the cam roller 54 and the position of the center of gravity 68 of the first lens 28. Accordingly, the damage to the straight roller 46 can be suppressed.

In addition, the rotating barrel 22 has the cam barrel 36 having the cam groove 48 and the connecting barrel 38 disposed on the image formation side with respect to the cam barrel 36 (see FIG. 7). The connecting barrel 38 is configured separately from the cam barrel 36 and is connected to the cam barrel 36. Therefore, the cam groove 48 can be formed by cutting in a state before the cam barrel 36 is assembled to the connecting barrel 38. Accordingly, for example, the cam groove 48 can be formed up to a position close to an end part of the cam barrel 36 on the connecting barrel 38 side as compared with a case where the cam barrel 36 is formed integrally with the connecting barrel 38. As a result, it is possible to suppress the cam barrel 36 and thus the rotating barrel 22 from being increased in size in the optical axis direction.

In addition, the connecting barrel 38 has the convex portion 88 that protrudes toward the image formation side, and the second lens frame 26 has the second impact receiving portion 66 that faces the convex portion 88 with the second gap 90 therebetween in the optical axis direction (see FIG. 16). The stationary barrel 18 has the support roller 62 that is engaged with the support groove 56 formed in the connecting barrel 38, and the support roller 62 is formed of an elastic material. The second gap 90 is a gap corresponding to the elastic region of the support roller 62. Therefore, in a case where the movable barrel 20 and the rotating barrel 22 are moved to the image formation side and the support roller 62 is elastically deformed due to an impact applied to the lens device 14 by dropping the imaging apparatus 10 or the like, the convex portion 88 abuts against the second impact receiving portion 66. Accordingly, since the support roller 62 can be suppressed from being plastically deformed beyond the elastic region, it is possible to suppress the rotational accuracy of the cam barrel 36 and the straight movement accuracy of the movable barrel 20 from being decreased. As a result, it is possible to suppress a decrease in the optical performance of the lens device 14.

In addition, the second lens frame 26 has the fixing portion 92 that is fixed to the imaging apparatus body 12, and at least a part of the second impact receiving portion 66 in the width direction overlaps with at least a part of the fixing portion 92 in the direction around the optical axis (see FIG. 19). Therefore, for example, the second impact receiving portion 66 can receive the impact at a position close to the fixing portion 92 as compared with a case where the second impact receiving portion 66 is shifted without overlapping with the fixing portion 92. Accordingly, it is possible to enhance the effect of suppressing the support roller 62 from being plastically deformed beyond the elastic region.

In addition, the stationary barrel 18 has the plurality of support rollers 62 (for example, three support rollers 62), and the second lens frame 26 has the plurality of second impact receiving portions 66 (for example, four impact receiving portions). Any one second impact receiving portion 66 of the plurality of second impact receiving portions 66 is provided at a position corresponding to any one support roller 62 of the plurality of support rollers 62 (see FIG. 18). Therefore, for example, it is possible to enhance the effect of suppressing any one of the support rollers 62 from being plastically deformed beyond the elastic region as compared with a case where each of the second impact receiving portions 66 is provided without corresponding to any of the support rollers 62.

In addition, any one second impact receiving portion 66 of the plurality of second impact receiving portions 66 (for example, four impact receiving portions) is provided at a position corresponding to any one first impact receiving portion 64 of the plurality of first impact receiving portions 64 (for example, three impact receiving portions) described above (see FIG. 20). As a result, for example, it is possible to enhance the effect of suppressing each of the cam rollers 54 corresponding to any one first impact receiving portion 64 and each of the support rollers 62 corresponding to any one second impact receiving portion 66 from being plastically deformed beyond the elastic region as compared with a case where each of the second impact receiving portions 66 is provided without corresponding to any of the first impact receiving portions 64.

### MODIFICATION EXAMPLE

In the above-described embodiment, the number of the plurality of second impact receiving portions 66 may be the same as the number of the plurality of support rollers 62. Each of the second impact receiving portions 66 may be provided at a position corresponding to each of the support rollers 62. In this manner, each of the second impact receiving portions 66 corresponding to each of the support rollers 62 can receive the impact. As a result, it is possible to enhance the effect of suppressing each of the support rollers 62 from being plastically deformed beyond the elastic region as compared with a case where each of the second impact receiving portions 66 is provided without corresponding to any of the support rollers 62.

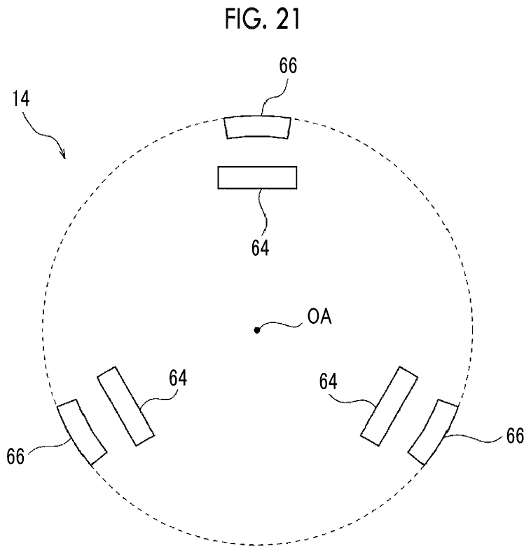

In addition, as shown in FIG. 21, the number of the plurality of second impact receiving portions 66 may be the same as the number of the plurality of first impact receiving portions 64. Then, each of the second impact receiving portions 66 may be provided at a position corresponding to each of the first impact receiving portions 64. In this manner, for example, it is possible to enhance the effect of suppressing each of the cam rollers 54 corresponding to each of the first impact receiving portions 64 and each of the support rollers 62 corresponding to each of the second impact receiving portions 66 from being plastically deformed beyond the elastic region as compared with a case where each of the second impact receiving portions 66 is provided without corresponding to any of the first impact receiving portions 64.

The contents described and shown above are detailed descriptions of portions related to the technology of the present disclosure and are merely an example of the technology of the present disclosure. For example, the description of the configuration, the function, the action, and the effect described above are the description of examples of the configuration, the function, the action, and the effect of the portions according to the technology of the present disclosure. As a result, it goes without saying that unnecessary portions may be deleted, new elements may be added, or replacements may be made with respect to the contents described and shown above without departing from the gist of the technology of the present disclosure. In addition, in order to avoid complication and facilitate the understanding of a portion according to the technology of the present disclosure, regarding the contents described and shown above, description related to common technical knowledge or the like which does not need to be particularly described to enable implementation of the technology of the present disclosure is omitted.

What is claimed is:

1. A lens device comprising:
a rotating barrel that includes a spiral cam groove;
a first lens frame that holds a first lens;
a movable barrel that includes a first engaging member engaged with the cam groove and holds the first lens frame; and
a stationary barrel that supports the movable barrel to be movable along a direction of an optical axis,
wherein the rotating barrel includes a first facing portion,
the movable barrel includes a second facing portion that faces the first facing portion with a first gap therebetween in the direction of the optical axis,
the first engaging member includes a first elastic region, and
the first gap is a gap corresponding to the first elastic region.

2. The lens device according to claim 1,
wherein in a case where a deformation amount of the first engaging member in the direction of the optical axis, which corresponds to a yield point of the first engaging member, is denoted by A [mm] and a dimension of the first gap in the direction of the optical axis is denoted by B [mm], Expression (1) is satisfied,
$$B < A . \qquad ( 1 )$$

3. The lens device according to claim 2,
wherein Expression (2) is satisfied,
$$A \times 0.7 \leq B < A . \qquad ( 2 )$$

4. The lens device according to claim 3,
wherein B=0.050 mm is satisfied.

5. The lens device according to claim 1,
wherein the first gap is a gap in which the second facing portion abuts against the first facing portion before the first engaging member is plastically deformed beyond the first elastic region.

6. The lens device according to claim 1,
wherein the first engaging member is a roller of a cam follower.

7. The lens device according to claim 1,
wherein a material of the first engaging member is a material including resin, rubber, or an elastomer.

8. The lens device according to claim 1,
wherein the first engaging member is a roller of a cam follower selected according to a dimension of a width of the cam groove.

9. The lens device according to claim 1,
wherein the first facing portion is formed on a side wall portion of the cam groove.

10. The lens device according to claim 9,
wherein the second facing portion is positioned on a subject side with respect to the side wall portion in the direction of the optical axis.

11. The lens device according to claim 1,
wherein at least a part of the second facing portion overlaps with at least a part of the first engaging member when viewed from the direction of the optical axis.

12. The lens device according to claim 1,
wherein the movable barrel includes
a plurality of the first engaging members, and
a plurality of the second facing portions, and
each of the second facing portions is provided at a position corresponding to each of the first engaging members.

13. The lens device according to claim 12,
wherein the number of the plurality of second facing portions is the same as the number of the plurality of first engaging members.

14. The lens device according to claim 1,
wherein the rotating barrel includes
a cam barrel including the cam groove, and
a connecting barrel disposed on an image formation side with respect to the cam barrel,
an end part of the movable barrel on the image formation side is positioned on a radially outer side of the cam barrel, and
the second facing portion is provided in a protruding shape on an inner peripheral surface of the end part.

15. The lens device according to claim 1,
wherein the stationary barrel includes a straight groove along the direction of the optical axis,
the movable barrel includes a second engaging member engaged with the straight groove, and
the second engaging member is disposed between a center of gravity position of the first lens and the first engaging member in the direction of the optical axis.

16. The lens device according to claim 1,
wherein the rotating barrel includes
a cam barrel including the cam groove, and
a connecting barrel disposed on an image formation side with respect to the cam barrel, and
the connecting barrel is configured separately from the cam barrel and is connected to the cam barrel.

17. The lens device according to claim 16,
wherein the connecting barrel includes a gear portion engaged with a drive unit.

18. The lens device according to claim 17,
wherein the gear portion is formed at an end part of the connecting barrel on the image formation side.

19. The lens device according to claim 16,
wherein the connecting barrel has a shape that increases in diameter toward the image formation side.

20. The lens device according to claim 16,
wherein an outer diameter of an end part of the connecting barrel on the image formation side is larger than an outer diameter of the cam barrel.

21. The lens device according to claim 16, further comprising:
a second lens frame that holds a second lens,
wherein the second lens includes
a third lens positioned on a radially inner side of the cam barrel, and
a fourth lens positioned on a radially inner side of the connecting barrel, and
an outer diameter of the fourth lens is larger than an outer diameter of the third lens.

22. The lens device according to claim 16,
wherein a material of the cam barrel is a material including a metal.

23. The lens device according to claim 1, further comprising:
a second lens frame that holds a second lens,
wherein the rotating barrel includes a support groove along a direction around the optical axis,
the stationary barrel includes a third engaging member engaged with the support groove,
the rotating barrel includes a third facing portion,
the second lens frame includes a fourth facing portion that faces the third facing portion with a second gap therebetween in the direction of the optical axis,
the third engaging member includes a second elastic region, and
the second gap is a gap corresponding to the second elastic region.

24. The lens device according to claim 23,
wherein the second gap is a gap corresponding to the first gap.

25. The lens device according to claim 23,
wherein the second lens frame includes a fixing portion that is fixed to an imaging apparatus body, and
at least a part of the fourth facing portion overlaps with at least a part of the fixing portion in the direction around the optical axis.

26. The lens device according to claim 23,
wherein the stationary barrel includes a plurality of the third engaging members,
the second lens frame includes a plurality of the fourth facing portions, and
at least one of the plurality of fourth facing portions is provided at a position corresponding to at least one of the plurality of third engaging members.

27. The lens device according to claim 23,
wherein the movable barrel includes a plurality of the second facing portions,
the second lens frame includes a plurality of the fourth facing portions, and
at least one of the plurality of fourth facing portions is provided at a position corresponding to at least one of the plurality of second facing portions.

28. An imaging apparatus comprising:
the lens device according to claim 1.
